(19) United States
(12) Patent Application Publication
(10) Pub. No.: US 2019/0069704 A1
(43) Pub. Date: Mar. 7, 2019

(54) HAND PEELER

(71) Applicant: Christophe MONTIGNY, Paris (FR)

(72) Inventor: Christophe MONTIGNY, Paris (FR)

(21) Appl. No.: 16/077,398

(22) PCT Filed: Feb. 11, 2017
(86) PCT No.: PCT/EP2017/053090

§ 371 Date: Aug. 10, 2018

(30) Foreign Application Priority Data
Feb. 11, 2016 (FR) 1600233

(51) Int. Cl. A47J 17/02

(52) U.S. Cl. CPC A47J 17/02

(57) ABSTRACT

The present invention relates to a hand peeling device with which accumulating peels can easily be disposed of. The technical field of the invention is that of new hand peelers fitted with a mobile part (30) that moves along the cutting system (10) fixed to a handle (20). This arrangement facilitates the removal of the peels and therefore allows the peeling device to remain efficient. The mobile part subsequently returns to its original position by means of a device (40) having a restoring force.

### TECHNICAL AREA

The present invention relates to hand peelers. It is designed to allow the release of peelings that tend to clutter the space between the blade and the cutting guide. This invention can be operated by the same hand holding the peeler. This saves time and avoids possible injury to the user, this one does not have to try to remove the peelings by intervening on the blade with the other hand.

### THE STATE OF THE ART

Before the arrival of the manual peelers, the fruits and vegetables were peeled with simple knives. Even today, this method is used by professional cooks because it allows to easily get rid of peelings.

However, this requires an experience that is difficult to access for those who are not in the business.

This is why a multitude of different tools have appeared, whether complex machines for peeling large quantities or hand peelers that are more accessible to the general public.

Among a multitude of different hand peelers, two have had notable success and are currently well known. The first is designed as a peeler knife with a cutting system in the extension of the handle. The second has a cutting system perpendicular to the handle. There are variations to these models with a process allowing a slight oscillation of the cutting system to better track the shapes of fruits and vegetables to be peeled.

Manual peelers are characterized by having a blade and a pressure bar for standardizing the thickness of the peelings. Thus, the user does not have to judge constantly the depth of cut and can simply pass the tool on the surface to be peeled for ease of use and thus a significant time saving.

It is known from the state of the art a device which has been the subject of a patent application FR 2746286 the purpose of this is to be able to adjust the cutting height and slide the peelers more easily. For this, this peeler is different from others to adjust the thickness of peelings.

This type of tool tries to solve the problem of peelings with a guide facilitating their evacuation. This is however insufficient and peelings also accumulate on these models or even get stuck.

It is known from the state of the art a device which has been the subject of a patent application WO2008087462 whose purpose is to guide the peelings to the side to prevent them from sticking to the blade or vegetables. Although the goal is the same, the process is different. Although peel flow is facilitated, it still does not prevent them from getting caught between the blade and the pressure bar.

The disadvantage of these devices is that the peelings tend to remain blocked between the blade and the cutting guide thereby forcing the user to interrupt the peeling to do the clear of the blade. In addition to the loss of time involved in this manipulation, having to intervene manually on the blade can be dangerous (risk of cut).

It is known from the state of the art a device which has been the subject of a patent application EP0329580 where the cutting system comprising the blade and the pressure bar or just a part of this system is retractable. This feature allows to fit the cutting system inside the handle, thus making the peelings fall by pressing the end of the handle.

The main disadvantage is a complex realization that can cause problems of additional financial cost during manufacture. This can also cause maintenance problems as some parts will be difficult to access for the cleaning. This can lead to a malfunction of the tool by the progressive bonding of the parts to each other and may also lead to a problem of hygiene in the long term.

Finally, this design doesn't allow to adapt this kind of methods for manual peelers whose cutting system is perpendicular to the handle or those equipped with an oscillating device of the cutting system.

### Presentation of the Invention

In order to overcome the disadvantages presented above, the invention proposes a different approach. Here, we are not trying to prevent the peelings from sticking to the cutting systems, but to get rid of them easily.

In order to achieve this, a moving pusher part is guided along the cutting system and manually operable to push the peelings to the end where the blade and the cutting guide bar meet. The peelings will so be cut by shearing.

At the same time, a piece with elastic properties will store some of the force used to push the moving part. It will then restore this force to allow the automatic return of the moving part to its original position.

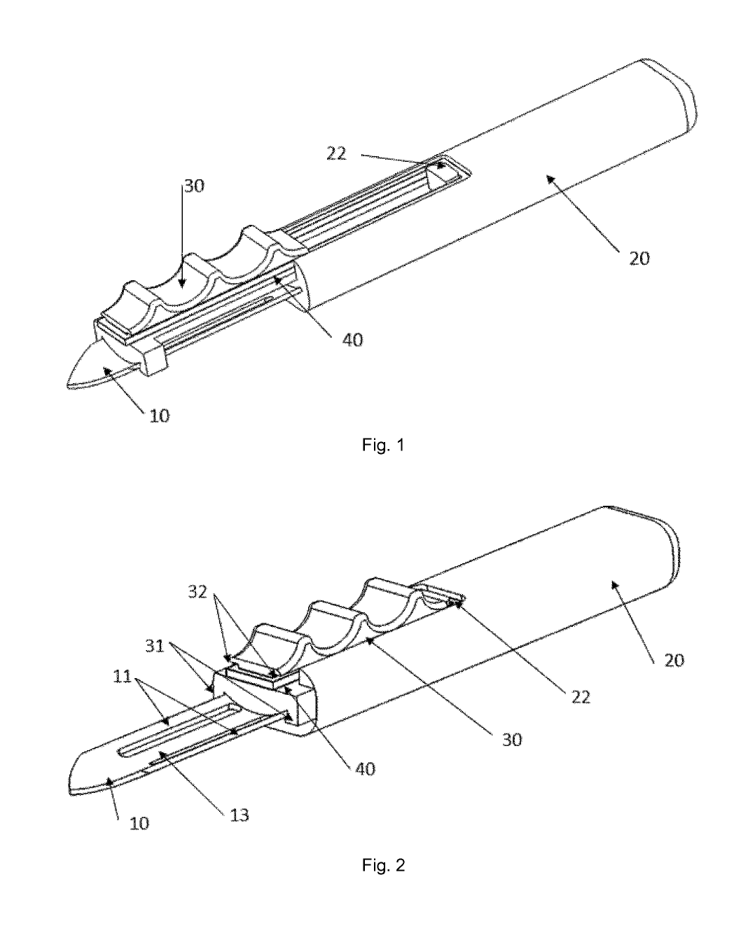

### DESCRIPTION OF FIG. 1

FIG. 1 shows a cutting system 10 mounted on a handle 20 in the original position. The cutting system 10 is provided with a double blade 13, two cutting guides 11 and is fixed to the handle 20 at one of these ends and parallel thereto. The groove 22 holds a resilient 40 in connection with the handle 20 and the movable part 30 thanks to the grooves 32. This piece 30 has two hooks 31 to hold it on the cutting system 10 while allowing it to slide on.

### DESCRIPTION OF FIG. 2

FIG. 2 shows the moving part 30 when pushed forward to get rid of the peelings. It also allows to better see the groove 22 of the handle and the elastic 40 when stretched.

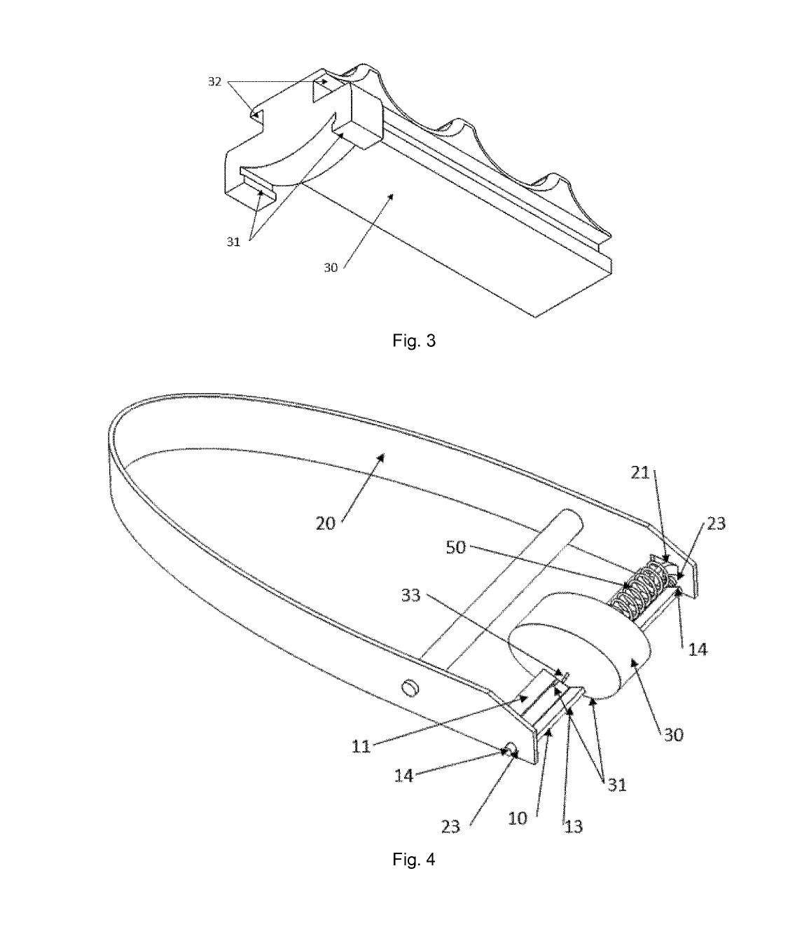

### DESCRIPTION OF FIG. 3

FIG. 3 shows the moving part 30 of FIGS. 1 and 2 to show the hooks 31 which maintains it on the cutting system and the grooves 32 which hold the elastic.

### DESCRIPTION OF FIG. 4

FIG. 4 shows the moving part 30 mounted on a hand peeler whose cutting system is perpendicular to the handle 20. This peeler also allows a slight oscillation of the cutting system 10. The cutting system 10 has two rounded ends 14 to allow its oscillation with respect to the handle 20, it is also provided with a blade 13 and a cutting guide 11The handle 20 has two holes 23 on each side in which the rounded ends 14 of the cutting system 10 are inserted. There is also a hook 21 for limiting the oscillation of the cutting system 10. The spring 50 allows the return to the original position of the movable part 30 to which it is held by the hole 33 on the moving part and around a rounded portion 14 on the cutting system 10. The moving part 30 can slide without separating from the cutting system 10 thanks to the hooks 31.

As goes without saying, the invention is not limited to the embodiments of this hand peeler which have been presented above as examples. It encompasses all variants of implementation and application respecting the same principle. This is so, in particular, that the peeling device object of the invention can also be designed with an intermediate system between the moving part and a manual action such as a gear system which makes it possible to multiply the distance or the effort obtained by the manual action. We can also consider a simple extension, fixed or not, to the moving part which will serve to facilitate the use of the mechanism if the cutting system is too far from the hand holding the manual peeler. It can also be envisaged that the moving part slides along the cutting system with another means than the hooks to allow translation.

1. A peeling device comprising a handle and a cutting system with at least one blade and a cutting guide, characterized in that it comprises a movable part which moves in translation in the longitudinal direction of the cutting system. The movement of this moving part makes it possible to remove the peelings from the peeling device in order to preserve its effectiveness.

2. Device according to the first claim, characterized in that the moving part automatically returns to its original position by means of a return mechanism.

3. Device according to the first claim wherein the moving part is mounted on an oscillating cutting system.

4. Device according to the first claim wherein the moving part is actuated via a gear system to multiply the distance travelled by the moving part.

5. Device according to the first claim wherein the moving part is actuated via an extension to allow reaching the end of the cutting system.

6. Device according to the first claim wherein the moving part blocks itself in original position.

7. Device according to the first claim wherein a stop prevents the moving part to unhook from the cutting system.
